(19) United States
(12) Patent Application Publication
(10) Pub. No.: US 2023/0271233 A1
(43) Pub. Date: Aug. 31, 2023

(54) SYSTEM FOR COLLECTING TRIPPER ROOM FUGITIVE DUST OF POWER PLANT COAL TRANSFER FACILITY

(71) Applicants: MICRO-ONE, Chungcheongnam-do (KR); KOREA EAST-WEST POWER CO., LTD., Ulsan (KR)

(72) Inventors: Heok Soo JEON, Cheonan-si (KR); Byeong Cheol KWAK, Suwon-si (KR); Jong Pyo KIM, Pohang-si (KR); Su Young CHOI, Daejeon (KR)

(21) Appl. No.: 18/012,793

(22) PCT Filed: Jul. 28, 2020
(86) PCT No.: PCT/KR2020/009899

§ 371 Date: Dec. 23, 2022

(30) Foreign Application Priority Data
Jun. 23, 2020 (KR) 10-2020-0076374

(51) Int. Cl. B08B 15/00; B01D 46/00

(52) U.S. Cl. CPC B08B 15/005; B01D 46/0039

(57) ABSTRACT

The present invention provides a system for collecting tripper room fugitive dust of a power plant coal transfer facility, wherein the system includes an entrance dust collection module disposed at the entrance of a tripper room to block dust; a tripper car configured to move along a transfer conveyor disposed inside the tripper room and transfer fuel introduced through the entrance to silos; and a main dust collection module configured prevent spread of dust by removing dust in response to movement of the tripper car and adjusting the pressure at the point where dust is generated.

### TECHNICAL FIELD

The present invention relates to a system for collecting tripper room fugitive dust, and more particularly, to a system for collecting tripper room fugitive dust of a power plant coal transfer facility, wherein the system is capable of improving safety by collecting harmful substances such as coal dust scattered in a closed tripper space of a power plant.

### BACKGROUND ART

Tripper and conveyor equipment play a role in transferring fossil fuel to a storage tank inside a boiler. Since environmental pollutants such as coal dust are generated in the transfer facility space (tripper room), the tripper room is formed in a closed structure.

Since the space of a tripper room is sealed, a dust collector must be installed inside the tripper room. However, in the case of a conventional tripper room, a lot of floating fuel and dust were generated in the tripper room due to poor performance and efficiency of a dust collector, which adversely affected facility safety.

To solve these problems, research is being conducted on a system that can more efficiently remove dust in a closed tripper space.

Republic of Korea Utility Model Publication No. 20-0436683 (“CLEAN ROOM FIRE HEAD SPACE SEALING DUST COLLECTOR”) (hereinafter referred to as Patent Document 1) discloses an apparatus capable of removing dust in an enclosed space. However, Patent Document 1 relates to a technique for removing fine dust in a clean room where microprocessing operations are performed to fabricate semiconductors, LCDs, PDPs, and the like. Thus, the technique of Patent Document 1 is difficult to apply to removing dust from a space where a huge amount of dust is generated, such as power plant facilities.

Korean Patent Application Publication No. 10-2010-0077237 (“TRIPPER TRANSFER APPARATUS”) (hereinafter referred to as Patent Document 2) discloses a tripper transfer apparatus configured to run along a rail and capable of improving the efficiency of collecting dust generated in the process of distributing raw materials transferred to a belt conveyor to a plurality of hoppers. However, in Patent Document 2, the dust of a tripper car may be reduced by simply installing an auxiliary dust collection pipe in the tripper car, but it is difficult to remove contaminants spreading throughout a tripper room.

Korean Patent Application Publication No. 20-0188751 (“DUST COLLECTOR IN TRIPPER CAR”) (hereinafter referred to as Patent Document 3) discloses a technique for removing dust generated from a tripper car by installing a guide pipe for guiding dust at the top of the tripper car. The technique of Patent Document 3 may only reduce the dust of a tripper car, but a system for controlling pollutants in the entire tripper room has not yet been developed.

### DISCLOSURE

### Technical Problem

Therefore, the present invention has been made in view of the above problems, and it is one object of the present invention to provide a system for collecting tripper room fugitive dust of a power plant coal transfer facility, wherein the system is capable of improving the safety of a closed tripper space by improving the structures of a pipe and tripper connected to a dust collection facility and increasing the efficiency of the dust collection facility.

### Technical Solution

In accordance with one aspect of the present invention, provided is a system for collecting tripper room fugitive dust of a power plant coal transfer facility, the system including an entrance dust collection module disposed at an entrance of a tripper room to block dust; a tripper car configured to move along a transfer conveyor disposed inside the tripper room and transfer fuel introduced through the entrance to silos; and a main dust collection module configured prevent spread of dust by removing dust in response to movement of the tripper car and adjusting pressure at a point where dust is generated.

According to one embodiment of the present invention, the main dust collection module may reduce pressure inside silos by sucking air inside the silos to prevent dust generated in the silos from leaking out of the silos, and when a tripper car unloads fuel into silos, the main dust collection module may suck air inside the tripper car to prevent dust generated in the unloading process from leaking out of the tripper car.

According to one embodiment of the present invention, the main dust collection module may include silo connection pipes connected to the silos to suck air inside the silos; tripper car connection pipes that are disposed above a travel path of the tripper car and suck air inside the tripper car; and a weight damper installed at one end of the tripper car connection pipe and opened and closed according to movement of the tripper car.

According to one embodiment of the present invention, the weight damper may include a rotation shaft coupled to the tripper car connection pipes; a blocking member that opens and closes the tripper car connection pipes by rotation of the rotation shaft; a connection arm member coupled to the rotation shaft to transmit rotational force; and roller members formed at one end of the connection arm member and configured to apply weight downward and roll in contact with the tripper car.

According to one embodiment of the present invention, at an upper portion of the tripper car, a vent formed to overlap the tripper car connection pipes; and a guide member formed to move in contact with the roller members and change positions of the roller members when the tripper car moves may be formed.

According to one embodiment of the present invention, the guide member may include a first guide portion formed in a shape of an inclined surface to guide movement of the roller members while the connection arm member maintains an angle of inclination with respect to a ground; and a second guide portion coupled to one end of the first guide portion and configured to guide rolling of the roller members while the connection arm member remains parallel to the ground.

According to one embodiment of the present invention, the main dust collection module may include a first dust collection module and a second dust collection module disposed to be spaced apart from each other according to a moving direction of the transfer conveyor.

According to one embodiment of the present invention, the first and second dust collection modules may include a ventilation hood that is disposed above the tripper car connection pipes and controls pressure of an upper portion of the tripper room.

According to one embodiment of the present invention, the system may further include an auxiliary dust collection module disposed in an inner space of the tripper room to remove fugitive dust in the room.

According to one embodiment of the present invention, the system may further include a control module for controlling driving of the modules, wherein the control module includes a sensor for detecting an angle of the connection arm member with respect to a ground and a controller that adjusts pressure distribution inside the tripper room by controlling driving of the dust collection modules according to detection by the sensor.

### Advantageous Effects

A system for collecting tripper room fugitive dust of a power plant coal transfer facility according to the present invention having the above configuration provides the following effects.

First, by introducing a space dust collection method in a tripper room, dust inside a tripper car can be prevented from spreading into the tripper room, and at the same time, dust existing in the tripper space can be sucked to improve the safety of the closed tripper space.

Second, when coal is unloaded from a tripper car using a weight damper, dust inside the tripper car can be intensively sucked automatically, so that the limited number of dust collectors can be used more efficiently.

Third, by intensively collecting dust at a point where the most dust is generated during a process, the flow of air inside a tripper room can be controlled, and residual dust can be greatly reduced.

Effects of the present invention are not limited to those mentioned above, and other effects not mentioned will be clearly understood by those skilled in the art from the description below.

### DESCRIPTION OF DRAWINGS

FIG. 1 illustrates the external structure of a tripper room according to one embodiment of the present invention.

FIG. 2 is a conceptual diagram of a system for collecting tripper room fugitive dust according to one embodiment of the present invention.

FIG. 3 is a schematic diagram of the internal structure of a tripper room according to one embodiment of the present invention.

FIG. 4 schematically shows the overall structure of a system for collecting tripper room fugitive dust of a power plant coal transfer facility according to one embodiment of the present invention.

FIG. 5 schematically illustrates a connection structure between a tripper car and a weight damper according to one embodiment of the present invention.

FIGS. 6 and 7 show data on dust removal rates in a tripper room when a system for collecting tripper room fugitive dust is not applied.

FIGS. 8 and 9 show data on dust removal rates in a tripper room when a system for collecting tripper room fugitive dust according to the present invention is applied.

FIG. 10 includes graphs showing change in dust amount over time when a system for collecting tripper room fugitive dust according to the present invention is operated.

FIG. 11 shows experimental data on dust removal rates over time when a system for collecting tripper room fugitive dust according to the present invention is operated.

FIG. 12 shows experimental data on air flow in a tripper room before a system for collecting tripper room fugitive dust is applied.

FIG. 13 shows data on dust distribution at 110 seconds after a process runs when a system for collecting tripper room fugitive dust is not applied.

FIG. 14 shows data on dust distribution at 220 seconds after a process runs when a system for collecting tripper room fugitive dust is not applied.

FIG. 15 shows experimental data on air flow in a tripper room when a system for collecting tripper room fugitive dust is applied.

FIG. 16 shows data on dust distribution at 110 seconds after a process runs when a system for collecting tripper room fugitive dust is applied.

FIG. 17 shows data on dust distribution at 220 seconds after a process runs when a system for collecting tripper room fugitive dust is applied.

### BEST MODE

Hereinafter, the present invention will be described in more detail with reference to the drawings.

In this specification, the same or similar elements are denoted by the same or similar reference numerals even in different embodiments, and the description thereof will be replaced by the first one. Singular expressions encompass plural expressions unless clearly specified otherwise in context.

In addition, as used in the following description, suffixes for components such as “module” or “part” are given only considering the ease of writing the specification, and the suffixes themselves are not used for the purpose of distinguishing the components from each other.

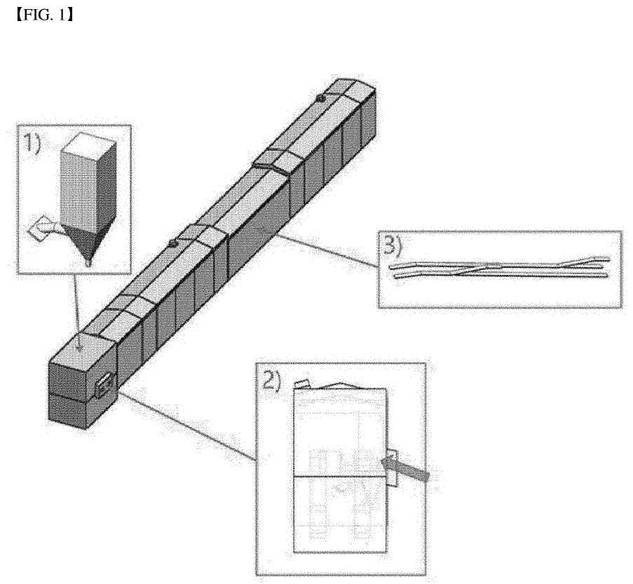

FIG. 1 illustrates the external structure of a tripper room according to one embodiment of the present invention.

Conventionally simple attempts were made to improve the working environment of a tripper room, but significant results were not obtained due to a large indoor space and a large amount of coal dust. Accordingly, methods such as wearing protective equipment and safety equipment and shortening a cleaning cycle were used.

To solve this problem, a dust collection facility was installed in a tripper room. However, the conventional dust collection facility has a local dust collection capacity of 560 m³/min, which is lower than a required capacity of 800 m³/min. In addition, due to limited facility operation, there was a problem that flow distribution was inappropriate.

To solve this problem, the present invention provides a system including a plurality of dust collection modules, being capable of strongly collecting dust at the point where the most dust is generated during a process, being capable of controlling the flow of air inside a tripper room, and being capable of dramatically reducing residual dust.

According to one embodiment of the present invention, dust collection modules are interlocked with a tripper car 311 and driven according to the process of loading, transferring, and unloading fuel.

For example, as shown in FIG. 1, 1) an entrance dust collection module 100 may be disposed at the entrance of a tripper room to remove dust generated while fuel is introduced into the tripper room, 2) a blocking wall 110 may be formed at an inlet to block dust from entering the tripper room from the outside, and 3) by combining a transfer conveyor and the tripper car 311, the driving force of dust collection modules and the flow of air in the room may be controlled according to the position of the tripper car 311, so that dust may be efficiently removed.

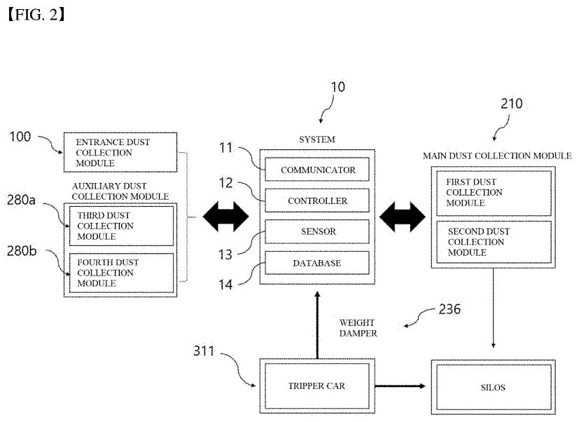

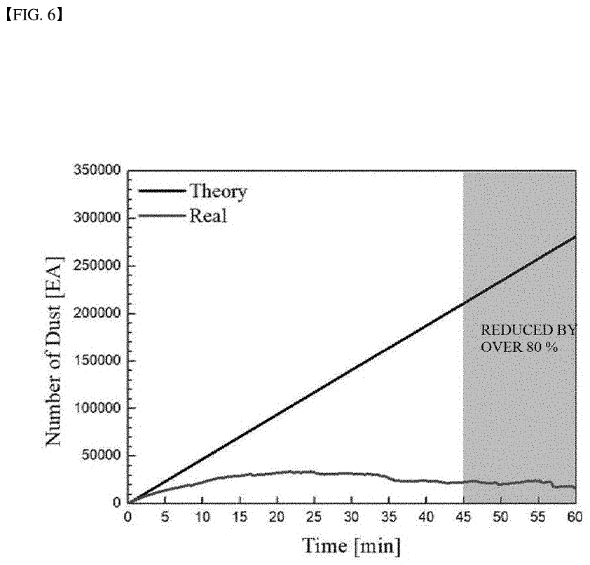

Hereinafter, a specific structure applied to the present invention will be described with reference to FIGS. 2 to 5, and a change in dust removal efficiency in a room according to this structure will be described with reference to FIGS. 6 to 17.

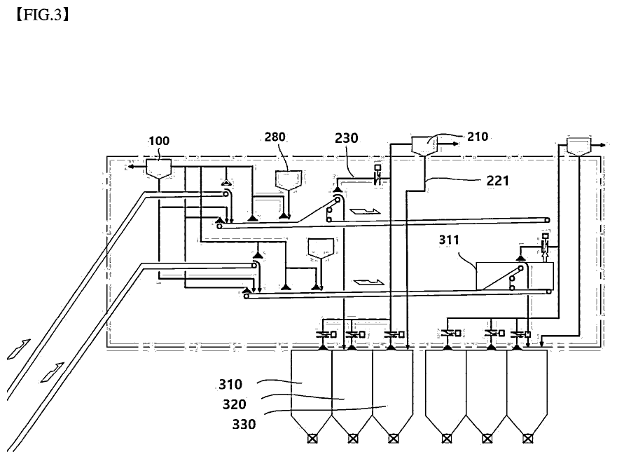

FIG. 2 is a conceptual diagram of a system for collecting tripper room fugitive dust according to one embodiment of the present invention, and FIG. 3 is a schematic diagram of the internal structure of a tripper room according to one embodiment of the present invention.

As shown in FIGS. 2 and 3, the system of the present invention may include a control module 10, a main dust collection module 210, the entrance dust collection module 100, an auxiliary dust collection module, the tripper car 311, silos, and the like.

The control module 10 checks the driving of the tripper car 311 and the driving of equipment inside a tripper room related to loading and unloading of coal, and controls the driving of each module.

The control module 10 may include a communicator 11, a controller 12, a sensor 13, a database 14, and the like. It is not necessary to include all of these detailed configurations as essential configurations. Optionally, only some configurations may be applied, or other detailed configurations may be added.

The communicator 11 receives or transmits signals for controlling the operation of modules. Both wired communication and wireless communication are applicable to the communicator 11 of the present invention.

The controller 12 controls the operation of modules based on data received from the sensor 13. For example, the controller 12 may control the driving force of the main dust collection module 210 and the auxiliary dust collection module according to the position or angle of a connection arm member detected by the sensor 13.

The sensor 13 may detect the distribution of dust inside a tripper room, the position of the tripper car 311, the positions of silos unloading coal, and the like. For this function, the sensor 13 may include a fine dust detection sensor, an infrared sensor, a position detection sensor, and the like.

In addition, the sensor 13 may detect whether a weight damper mounted on the connection pipe of the tripper car 311 is opened or closed, the position and angle of the connection arm member of a weight damper or the position and angle of roller members, and the arrangement of the blocking member, and may transmit related data to the controller 12.

The database 14 may collect data such as the distribution of dust according to a process, the flow of air in the room according to the operation of the dust collection modules, and dust removal efficiency, and may reflect the data to the process. That is, according to one embodiment of the present invention, using the data collected by the database 14, dust removal efficiency may be improved, and facility automation may be realized.

The main dust collection module 210 may perform a function of adjusting the pressure of each part by sucking air inside the tripper car 311 and the silos. That is, according to the present invention, in addition to removing dust, the main dust collection module 210 perform a function of adjusting the air flow in the room by adjusting the pressure at a specific location.

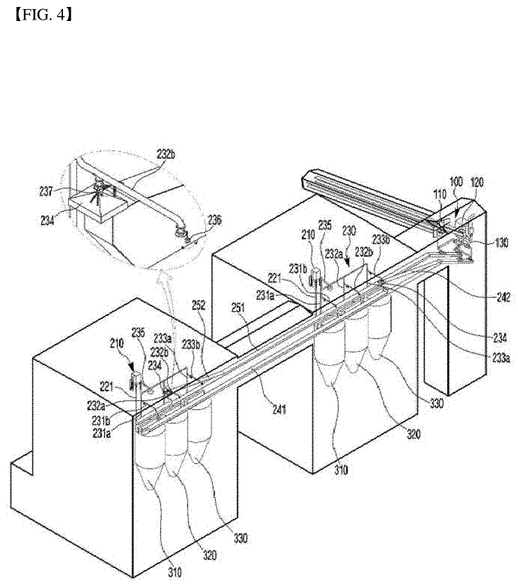

The main dust collection module 210 may consist of a plurality of dust collection modules disposed to be spaced apart from each other. For example, as shown in FIG. 4, the main dust collection module 210 may include a first dust collection module 210a and a second dust collection module 210b disposed to be spaced apart from each other in the moving direction of a transfer conveyor.

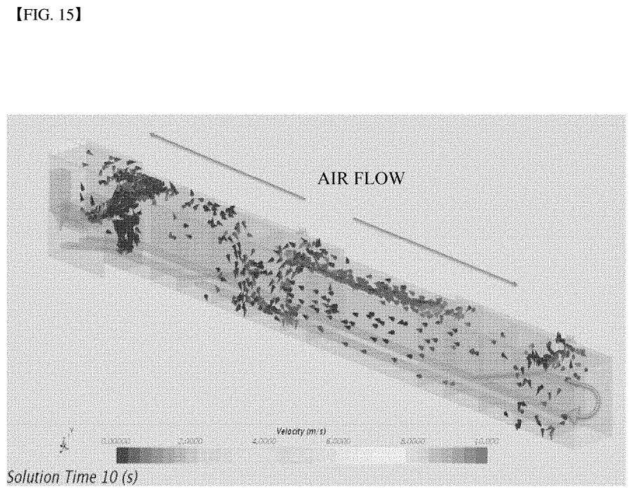

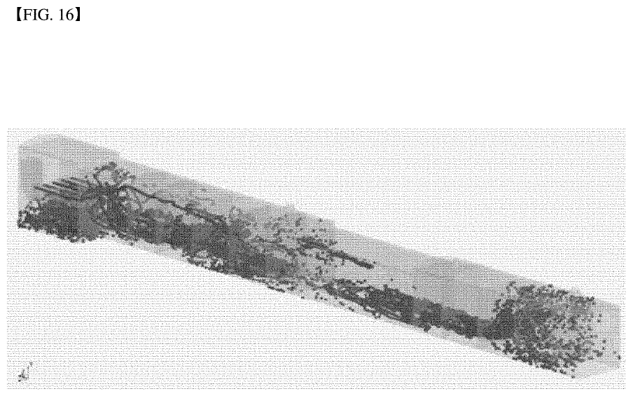

According to an embodiment of the present invention, since the first and second dust collection modules 210a and 210b are disposed to be spaced apart from each other in the moving direction of a transfer conveyor, when the main dust collection module 210 is driven, the direction of air flow in the room may be changed from one direction to both directions (see FIG. 15).

Referring to FIG. 3, the main dust collection module 210 may include silo connection pipes that are connected to the silos and suck air inside the silos and tripper car connection pipes that are disposed above the travel path of the tripper car 311 and suck air inside the tripper car 311.

The number of silos may be changed according to the amount of fuel stored. As shown in FIG. 3, a first silo 310, a second silo 320, and a third silo 330 may be arranged to be connected to each other.

In FIG. 3, three silos are connected to one dust collection module, but this configuration is for convenience of explanation, and the size and number of silos may be increased or decreased.

A weight damper opened and closed according to the movement of the tripper car 311 may be installed at one end of the tripper car connection pipe.

The auxiliary dust collection module is formed to assist the main dust collection module 210 to remove fugitive dust in the room. The auxiliary dust collection module is not an essential component and may be installed as needed.

The auxiliary dust collection module may include a third dust collection module 280a and a fourth dust collection module 280b disposed to be spaced apart from each other. The positions of the third and fourth dust collection modules 280a and 280b may be changed according to air flow analysis.

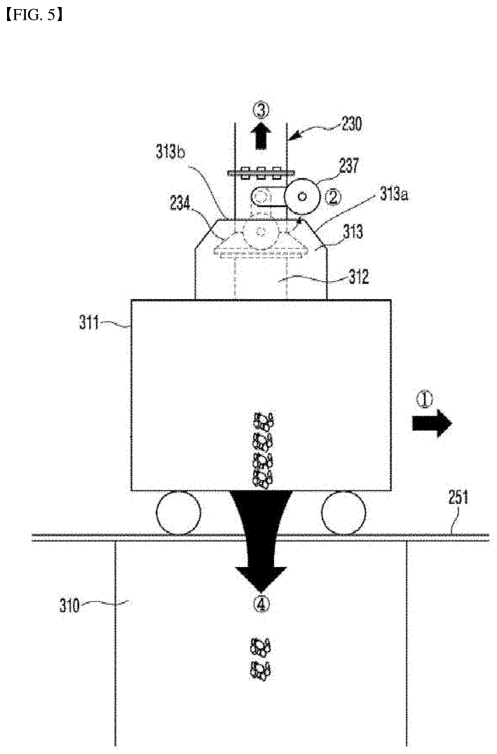

FIG. 4 schematically shows the overall structure of a system for collecting tripper room fugitive dust of a power plant coal transfer facility according to one embodiment of the present invention, and FIG. 5 schematically illustrates a connection structure between the tripper car 311 and the weight damper according to one embodiment of the present invention.

Referring to FIG. 4, the tripper room may include the entrance dust collection module 100, the main dust collection module 210, a pair of transfer conveyors, a plurality of silos, the tripper car 311, and the like.

The entrance dust collection module 100 may include an upper hood 120, a lower hood 130, the dust blocking wall 110, and the like.

The upper and lower hoods 120 and 130 may remove dust by sucking air at the upper and lower portions of the entrance and simultaneously adjust air pressure at the upper and lower portions of the entrance.

The dust blocking wall 110 blocks dust generated from fuel entering a tripper room along a conveyor from entering the tripper room.

The main dust collection module 210 may include the first and second dust collection modules 210a and 210b.

The first and second dust collection modules 210a and 210b may have the same configuration and be disposed to be spaced apart from each other in the extension direction of a transfer conveyor.

The first and second dust collection modules 210a and 210b may include a dust pipe 221 for discharging dust collected in a dust collector body and connection pipes for sucking air inside the silos and the tripper car 311.

As shown in FIG. 4, three silos are disposed under the main dust collection module 210, and the connection pipes are branched and connected to the three silos, respectively.

More specifically, the connection pipes may include a first silo connection pipe 231a connected to the first silo 310, a first tripper car connection pipe 231b branched from the first silo connection pipe 231a and having an end disposed above a transfer conveyor, a second silo connection pipe 232a connected to the second silo 320, a second tripper car connection pipe 232b branched from the second silo connection pipe 232a and having an end disposed above the transfer conveyor, a third silo connection pipe 233a connected to the third silo 330, and a third tripper car connection pipe 233b branched from the third silo connection pipe 233a and having an end disposed above the transfer conveyor.

According to another embodiment of the present invention, an opening/closing module for controlling an opening degree may be mounted on the connection pipes. The opening/closing module may be controlled by the controller 12, and the controller 12 may control each opening/closing module according to the concentration of fine dust or the distribution of fine dust in the room.

The ends of the first to third tripper car connection pipes 231b, 232b, and 233b may each be equipped with a weight damper. The weight damper is configured to open and close in response to the movement of the tripper car 311.

A weight damper hood 234 may be mounted at the end of the tripper car connection pipe.

The weight damper hood 234 is configured to overlap a vent 312 of the tripper car 311 to improve the performance of sucking air inside the tripper car 311.

According to one embodiment of the present invention, the connection pipe may include a ventilation hood 235.

The ventilation hood 235 may be formed on a main connection pipe before the tripper car connection pipes and the silo connection pipes diverge.

The term “main connection pipe” is used for convenience of explanation. As shown in FIG. 4, among the connection pipes extending from the dust collector body, a piping section before the tripper car connection pipes and the silo connection pipes diverge is referred to as the main connection pipe.

The ventilation hood 235 may be set to remove residual fugitive dust for a certain period of time after a process is stopped. In this case, the controller 12 may close the tripper car connection pipes and the silo connection pipes and keep only the ventilation hood open.

The transfer conveyor forms an inclined surface 242 to enter the inside of the tripper car 311.

The transfer conveyor may consist of a pair of conveyors (a first conveyor 241 and a second conveyor 251) that are parallel to each other.

The tripper car 311 moving along the first conveyor 241 and the tripper car 311 moving along the second conveyor 251 may be configured to unload coal to different main dust collection modules 210.

For example, while the tripper car 311 moving along the first conveyor 241 unloads coal into a silo under the first dust collection module 210a, the tripper car 311 moving along the second conveyor 251 may unload coal into a silo under the second dust collection module 210b.

In addition, according to one embodiment of the present invention, the tripper car 311 moving along the first conveyor 241 and the tripper car 311 moving along the second conveyor 251 may be arranged to move in opposite directions.

Due to this arrangement, when one tripper car 311 performs a task of unloading coal on the left side of a tripper room, the other tripper car 311 performs a task of unloading coal on the right side of the tripper room. Since the driving of the dust collection modules is controlled according to the position of the tripper car 311, air flow in the room may be changed from one direction to both directions. Through this configuration, dust collection efficiency may be maximized by using a small number of dust collection modules.

Referring to FIG. 5, the weight damper may include a rotation shaft coupled to the tripper car connection pipes, a blocking member configured to open and close the tripper car connection pipes by rotation of the rotation shaft, a connection arm member coupled to the rotation shaft to transmit rotational force, and roller members formed at one end of the connection arm member and configured to apply weight downward and roll in contact with the tripper car 311.

At the upper portion of the tripper car 311, the vent 312 formed to overlap the tripper car connection pipe and a guide member 313 formed to move in contact with the roller members of the weight damper and change the position of the roller members when the tripper car 311 moves may be formed.

The vent 312 is connected to the end of the tripper car connection pipe so that the dust collection module sucks air inside the tripper car 311.

According to one embodiment of the present invention, the guide member 313 may include a first guide portion 313a and a second guide portion 313b.

The first guide portion 313a may be formed in the shape of an inclined surface or a curved surface to guide the movement of the roller members while a connection arm member maintains an angle of inclination with respect to the ground.

The second guide portion 313b may be coupled to one end of the first guide portion 313a and formed in a flat shape to guide rolling of the roller members while the connection arm member remains parallel to the ground.

The controller 12 may prepare a process for intake of air inside the tripper car 311 when the tripper car 311 enters and the connection arm member forms an angle of inclination with respect to the ground. By introducing the preparation process, the flow of air in the room may be smoothed and vortex may be generated in the room, thereby preventing dust from spreading.

During the preparation process, suction force through the silo connection pipes and the tripper car connection pipes connected to other silos other than silos disposed under the tripper car 311 is reduced.

By reducing the suction power of other connection pipes during the preparation process, the internal pressure of silos other than silos connected to the tripper car 311 is increased. When the tripper car 311 moves further and the connection arm member is disposed parallel to the ground, the air inside the tripper car 311 is sucked in and the pressure inside the tripper car 311 is reduced.

That is, it is possible to maintain a smooth flow of air by sequentially changing the pressure of adjacent areas.

When a process of unloading coal is completed and the tripper car 311 moves out of the unloading area, the connection arm member forms an angle of inclination with respect to the ground again, and the controller 12 detects the operation and increases the suction power of the silo connection pipes to change the generated air flow downward.

In addition, according to another embodiment of the present invention, an air pressure measurement sensor for measuring air pressure may be installed at an end of each connection pipe.

Based on data collected from air pressure measurement sensors, when the tripper car 311 overlaps any one tripper car connection pipe and a process of sucking the air inside the tripper car 311 proceeds, the controller 12 may adjust the suction force of each connection pipe so that the air pressure at a location further away from the location where the tripper car 311 is disposed increases.

That is, by minimizing the air pressure at the location where the tripper car 311 is placed during unloading of coal, the amount of dust emitted from the tripper car 311 may be reduced and dust removal efficiency may be improved.

When the tripper car 311 is moving, the suction force of each connection pipe may be adjusted so that the air pressure at a farther away location increases based on a silo in which coal was unloaded immediately before.

That is, the amount of dust discharged from the inside of silos may be reduced while unloading of coal is completed and the tripper car 311 moves, and dust removal efficiency may be improved.

As described above, the main dust collection module 210 may perform a function of adjusting the pressure of each part by sucking the air inside the tripper car 311 and the air inside of the silos. That is, in the present invention, in addition to dust removal, the main dust collection module 210 performs a function of adjusting the air flow in the room by adjusting the pressure at a specific location.

Hereinafter, the effect of the system for collecting tripper room fugitive dust of a power plant coal transfer facility according to the present invention will be described in detail through the experimental data.

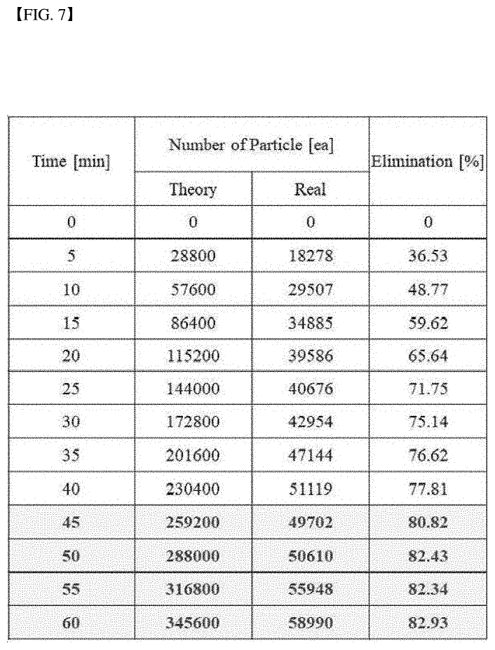

FIGS. 6 and 7 show data on dust removal rates in a tripper room when a system for collecting tripper room fugitive dust is not applied.

Referring to FIGS. 6 and 7, the dust removal rate of the conventional tripper room is about 80% from 45 minutes, and when loading coal up to 60 minutes, the removal rate is about 82.93%. Here, the theoretical value means the amount of dust generated over time, and the real value means the amount of dust remaining when the dust collection module is operated.

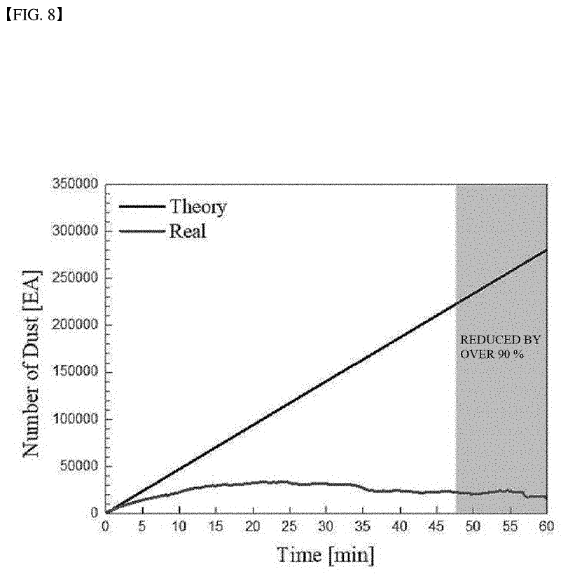

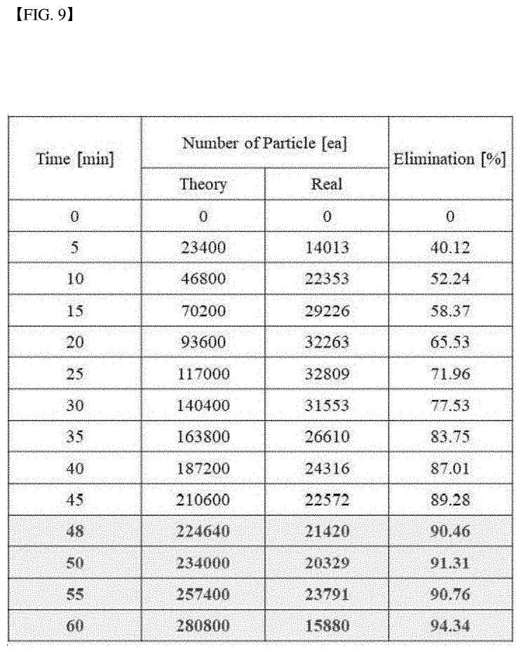

FIGS. 8 and 9 show data on dust removal rates in a tripper room when a system for collecting tripper room fugitive dust according to the present invention is applied.

As shown in FIGS. 8 and 9, the dust removal rate in a tripper room is over 90.46% from 48 minutes. In the case of coal loading up to 60 minutes, the dust removal rate is about 94.34%.

According to these data, when the system of the present invention is applied, the dust collection efficiency may be increased by 10% or more, and the environment inside the tripper room may be improved even when the dust collection module is operated for a shorter time.

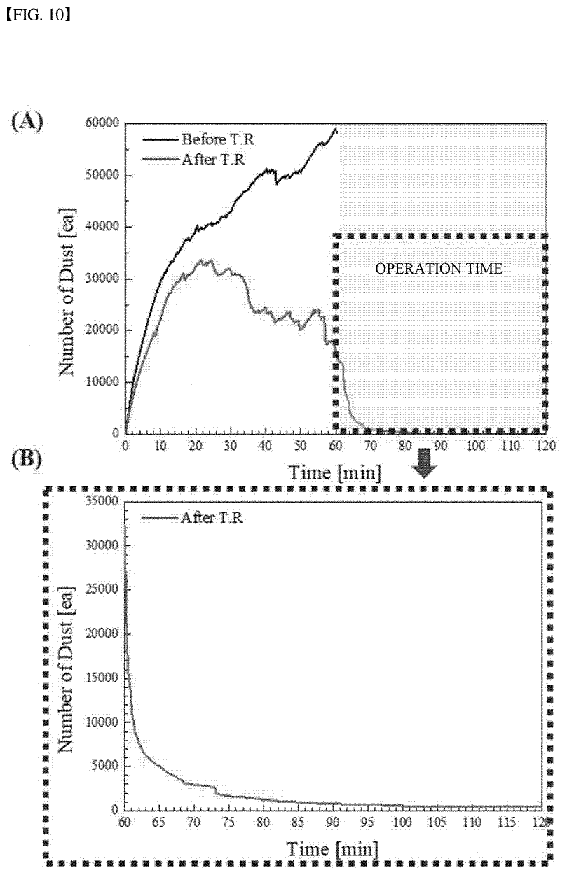

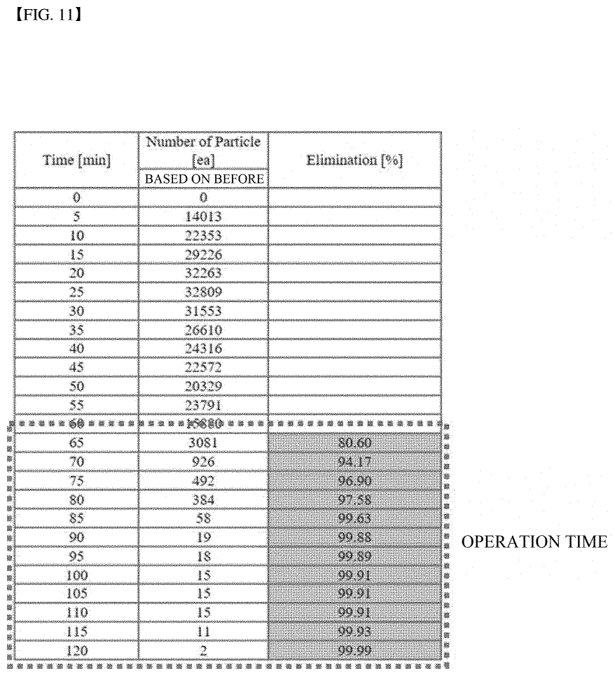

FIG. 10 includes graphs showing change in dust amount over time when a system for collecting tripper room fugitive dust according to the present invention is operated, and FIG. 11 shows experimental data on dust removal rates over time when a system for collecting tripper room fugitive dust according to the present invention is operated.

As shown in FIG. 10, the amount of dust when the system of the present invention is not applied (before T.R.) and the amount of dust when the system of the present invention is applied (after T.R.) may be confirmed in the graph. According to FIGS. 10 and 11, 80% of the dust is reduced within 5 minutes after starting the system.

FIG. 10B shows that 80% of dust is reduced within 5 minutes when the system is operated at the point where the most dust is generated.

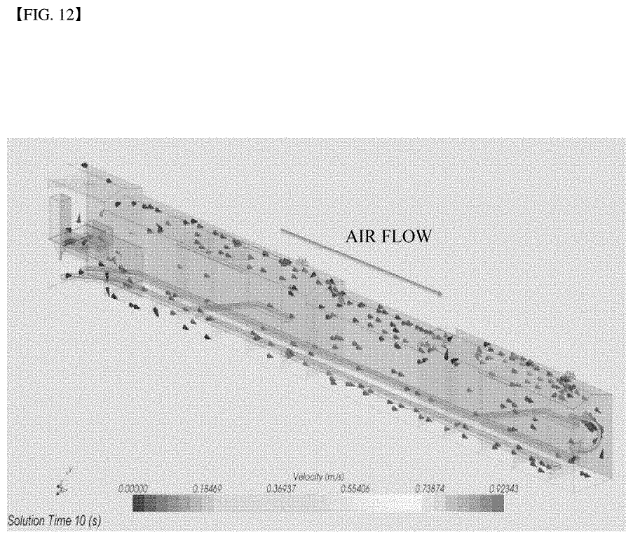

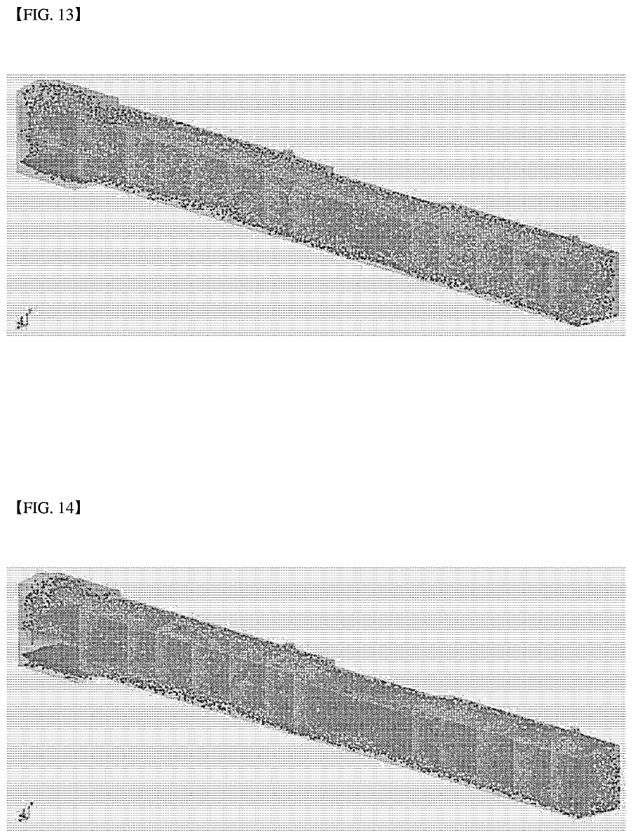

FIG. 12 shows experimental data on air flow in a tripper room before a system for collecting tripper room fugitive dust is applied, FIG. 13 shows data on dust distribution at 110 seconds after a process runs when a system for collecting tripper room fugitive dust is not applied, and FIG. 14 shows data on dust distribution at 220 seconds after a process runs when a system for collecting tripper room fugitive dust is not applied.

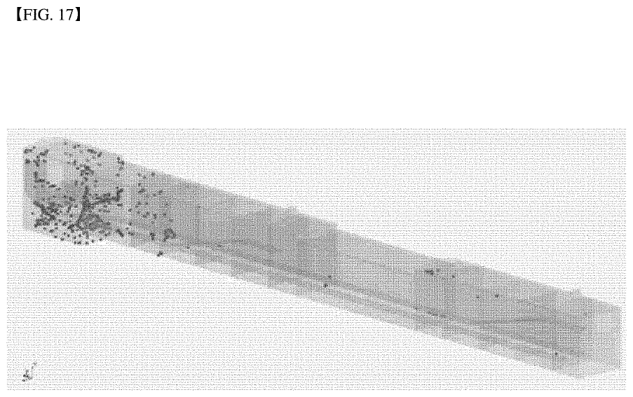

FIG. 15 shows experimental data on air flow in a tripper room when a system for collecting tripper room fugitive dust is applied, FIG. 16 shows data on dust distribution at 110 seconds after a process runs when a system for collecting tripper room fugitive dust is applied, and FIG. 17 shows data on dust distribution at 220 seconds after a process runs when a system for collecting tripper room fugitive dust is applied.

Referring to FIGS. 12 to 17, before the system of the present invention is applied, air flow occurs in one direction inside the tripper room. Due to this air flow, dust is spread throughout the tripper room. On the other hand, when the system of the present invention is applied, inside the tripper room, air flows in two directions, and due to the improved efficiency of the dust collection module, dust remains only on the entry side over time.

More specifically, referring to FIGS. 13 and 14, 110 seconds after the process of loading coal starts, dust starts to spread according to one-way air flow (see FIG. 12), and the dust scatters throughout the tripper room after 220 seconds.

In contrast, referring to FIGS. 16 and 17, 110 seconds after the process of loading coal starts, dust spreads to both sides according to bi-directional air flow (see FIG. 15), and the dust inside the tripper room is efficiently removed by the dust collection modules installed on both sides of the tripper room. In addition, as the flow of air is changed in both directions, dust generated at the entrance may be prevented from spreading into the tripper room.

According to at least one embodiment of the present invention described above, by introducing a space dust collection method in a tripper room, dust inside a tripper car may be prevented from spreading into the tripper room, and at the same time, dust existing in the tripper space may be sucked to improve the safety of the closed tripper space. In addition, when coal is unloaded from a tripper car using a weight damper, dust inside the tripper car may be intensively sucked automatically, so that the limited number of dust collectors may be used more efficiently. In addition, by intensively collecting dust at a point where the most dust is generated during a process, the flow of air inside a tripper room may be controlled, and residual dust may be greatly reduced. As such, an advanced effect compared to the prior art may be expected.

The present invention described above is not limited to the configuration and method of the embodiments described above, but all or part of each embodiment may be selectively combined so that various modifications may be made to the above embodiments.

1. A system for collecting tripper room fugitive dust of a power plant coal transfer facility, comprising:
an entrance dust collection module disposed at an entrance of a tripper room to block dust;
a tripper car configured to move along a transfer conveyor disposed inside the tripper room and transfer fuel introduced through the entrance to silos; and
a main dust collection module configured prevent spread of dust by removing dust in response to movement of the tripper car and adjusting pressure at a point where dust is generated.

2. The system according to claim 1, wherein the main dust collection module reduces pressure inside silos by sucking air inside the silos to prevent dust generated in the silos from leaking out of the silos, and when a tripper car unloads fuel into silos, the main dust collection module sucks air inside the tripper car to prevent dust generated in the unloading process from leaking out of the tripper car.

3. The system according to claim 2, wherein the main dust collection module comprises silo connection pipes connected to the silos to suck air inside the silos;
tripper car connection pipes that are disposed above a travel path of the tripper car and suck air inside the tripper car; and
a weight damper installed at one end of the tripper car connection pipe and opened and closed according to movement of the tripper car.

4. The system according to claim 3, wherein the weight damper comprises a rotation shaft coupled to the tripper car connection pipes;
a blocking member that opens and closes the tripper car connection pipes by rotation of the rotation shaft;
a connection arm member coupled to the rotation shaft to transmit rotational force; and
roller members formed at one end of the connection arm member and configured to apply weight downward and roll in contact with the tripper car.

5. The system according to claim 4, wherein, at an upper portion of the tripper car, a vent formed to overlap the tripper car connection pipes; and a guide member formed to move in contact with the roller members and change positions of the roller members when the tripper car moves are formed.

6. The system according to claim 5, wherein the guide member comprises a first guide portion formed in a shape of an inclined surface to guide movement of the roller members while the connection arm member maintains an angle of inclination with respect to a ground; and
a second guide portion coupled to one end of the first guide portion and configured to guide rolling of the roller members while the connection arm member remains parallel to the ground.

7. The system according to claim 6, further comprising an auxiliary dust collection module disposed in an inner space of the tripper room to remove fugitive dust in the room, wherein a driving force of the auxiliary dust collection module is adjusted according to an angle change of the connection arm member.

8. The system according to claim 6, wherein the main dust collection module comprises a first dust collection module and a second dust collection module disposed to be spaced apart from each other according to a moving direction of the transfer conveyor.

9. The system according to claim 8, wherein the first and second dust collection modules comprise a ventilation hood that is disposed above the tripper car connection pipes and controls pressure of an upper portion of the tripper room.

10. The system according to claim 9, further comprising a control module for controlling driving of the modules, wherein the control module comprises a sensor for detecting an angle of the connection arm member with respect to a ground and a controller that adjusts pressure distribution inside the tripper room by controlling driving of the dust collection modules according to detection by the sensor.
